(19) United States
(12) Patent Application Publication
(10) Pub. No.: US 2019/0205297 A1
(43) Pub. Date: Jul. 4, 2019

(54) INDEX GENERATING APPARATUS, INDEX GENERATING METHOD, AND COMPUTER-READABLE RECORDING MEDIUM

(71) Applicant: FUJITSU LIMITED, Kawasaki-shi (JP)

(72) Inventors: Chen DENG, Yokohama (JP); Masahiro KATAOKA, Kamakura (JP); Takehiro IDE, Mishima (JP)

(73) Assignee: FUJITSU LIMITED, Kawasaki-shi (JP)

(21) Appl. No.: 16/220,036

(22) Filed: Dec. 14, 2018

(30) Foreign Application Priority Data
Jan. 4, 2018 (JP) 2018-000329

(51) Int. Cl. G06F 16/242; G06F 16/22; G06F 16/31

(52) U.S. Cl. CPC G06F 16/2435; G06F 16/313; G06F 16/2445; G06F 16/2228

(57) ABSTRACT

A non-transitory computer-readable recording medium stores therein an index generating program that causes a computer to execute a process including: inputting control statements including plural phrases and having contents that change according to description positions of the plural phrases; generating first index information related to positional information of each of the phrases in the control statements; and generating, from the first index information, a second index information group related to the phrases targeted by each of reserved words included in the control statements.

### CROSS-REFERENCE TO RELATED APPLICATION

This application is based upon and claims the benefit of priority of the prior Japanese Patent Application No. 2018-000329, filed on Jan. 4, 2018, the entire contents of which are incorporated herein by reference.

### FIELD

The embodiments discussed herein are related to an index generating apparatus, an index generating method, and a computer-readable recording medium.

### BACKGROUND

In SQL statements, control contents are described with control statements having reserved words, such as SELECT, WHERE, and FROM, and sets of target data serving as targets of the reserved words, used therein. An application that processes the SQL statements executes specific operations on a database, based on the reserved words and sets of target data described in the SQL statements.

Patent Document 1: Japanese Laid-open Patent Publication No. 2007-310845

### SUMMARY

According to an aspect of the embodiment, a non-transitory computer-readable recording medium stores therein an index generating program that causes a computer to execute a process including: inputting control statements including plural phrases and having contents that change according to description positions of the plural phrases; generating first index information related to positional information of each of the phrases in the control statements; and generating, from the first index information, a second index information group related to the phrases targeted by each of reserved words included in the control statements.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram illustrating an example of a configuration of an information processing apparatus according to an embodiment;

FIG. 2 is a diagram illustrating an example of a configuration of a basic index according to the embodiment;

FIG. 3 is a diagram illustrating an example of a configuration of an address table according to the embodiment;

FIG. 4 is a diagram illustrating an example of a configuration of an upper hierarchical layer index group according to the embodiment;

FIG. 5 is a diagram illustrating an example of search processing for a SQL statement, according to an embodiment;

FIG. 6 is a diagram illustrating another example of the search processing for a SQL statement, according to the embodiment;

FIG. 7 is a diagram illustrating an example of a flow of an index generating process according to an embodiment;

FIG. 8 is a diagram illustrating an example of a flow of search processing according to an embodiment;

FIG. 9 is a diagram illustrating an example of a hardware configuration of a computer;

FIG. 10 is a diagram illustrating an example of a configuration of a program that runs on the computer; and

FIG. 11 is a diagram illustrating an example of a configuration of apparatuses in a system according to an embodiment.

### DESCRIPTION OF EMBODIMENT(S)

However, when target data described in SQL statements are searched for, not only the name of the target data is simply searched for, but also the reserved word targeting the target data needs to be searched for. For example, when target data described in SQL statements are searched for, a full-text search with a reserved word of the SQL statements, extraction of a set of data subsequent to the reserved word to be searched for, and determination of whether the extracted set of data meet the search criteria are needed. Therefore, sometimes a search for target data described in SQL statements takes time.

Preferred embodiments will be explained with reference to accompanying drawings. The scope of rights is not limited by these embodiments. The embodiments may be combined, as appropriate, so long as no contradictions in the processing content arise from the combination.

Configuration of Information Processing Apparatus According to Embodiment

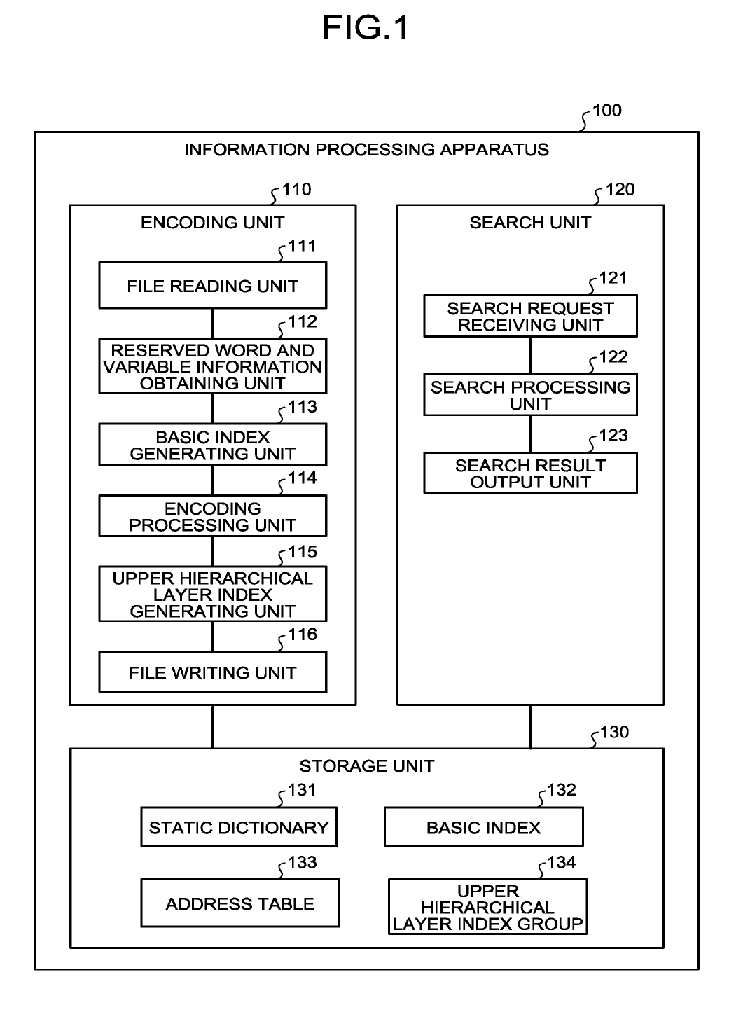

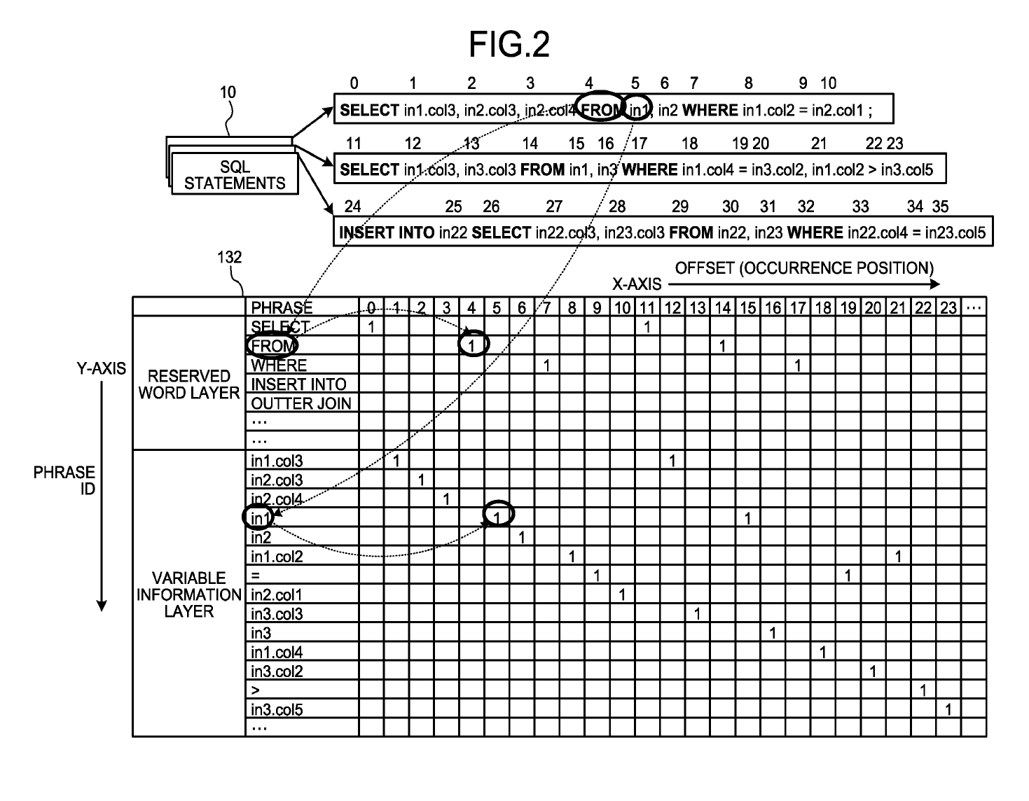

FIG. 1 is a functional block diagram illustrating an example of a configuration of an information processing apparatus 100 according to an embodiment. The information processing apparatus 100 inputs therein SQL statements 10 (see FIG. 2) described with combinations of reserved words and sets of target data, and generates a basic index 132 related to occurrence positions of phrases included in the SQL statements 10 input.

The SQL statements 10 are an example of control statements, and are statements for obtainment of target data from a database. An example of the SQL statements 10 according to the embodiment will now be described by reference to FIG. 2. FIG. 2 is a diagram illustrating an example of a configuration of the basic index 132 according to the embodiment. For example, in one of the SQL statements 10, “SELECT in1.col3, in2.col3, in2.col4 FROM in1, in2 WHERE in1.col2=in2.col1;”, phrases, “SELECT”, “FROM”, and “WHERE”, are an example of the reserved words, and the other phrases are an example of variable information. Further, among the variable information, “in1.col3”, “in2.col3”, “in2.col4”, “in1”, “in2”, “in1.col2”, and “in2.col1” are an example of the target data.

The notation, “in1”, according to this embodiment indicates that the name of the target data is “in1”, and the notation, “in1.col3”, indicates that the target data are data in the third column of the target data, “in1”. Further, in the SQL statements 10: the reserved word, “SELECT”, specifies “data of which items (columns) are to be searched for”; the reserved word, “FROM”, specifies “from which target data to perform a search”, and the reserved word, “WHERE”, specifies “under which conditions rows are searched”. In description of this embodiment, for ease of understanding, the reserved words in the SQL statements 10 are illustrated in boldface.

As illustrated in FIG. 1, the information processing apparatus 100 has an encoding unit 110, a search unit 120, and a storage unit 130. The storage unit 130 corresponds to a storage device, such as a non-volatile semiconductor memory element, for example, a flash memory or a ferroelectric random access memory (FRAM) (registered trademark). The storage unit 130 has a static dictionary 131, the basic index 132, an address table 133, and an upper hierarchical layer index group 134. The basic index 132 is an example of first index information. The upper hierarchical layer index group 134 is an example of a second index information group.

The static dictionary 131 is a dictionary, in which shorter codes are assigned to reserved words and pieces of variable information higher in frequency of occurrence, the reserved words and pieces of variable information occurring in the SQL statements 10, the frequency of occurrence having been determined based on any of general English dictionaries, other language dictionaries, and textbooks. The static dictionary 131 has static codes, which are the codes corresponding respectively to the reserved words and pieces of variable information, registered therein beforehand.

The basic index 132 is an aggregate of basic bitmaps, the aggregate being an index indicating existence or non-existence of the reserved words and pieces of variable information included in the SQL statements 10 at each offset (occurrence position). Next, details of the basic index 132 will be described by reference to FIG. 2.

The basic index 132 is formed of bit strings having pointers and bits connected to each other, the pointers respectively specifying the phrases included in the SQL statements 10 to be encoded, the bits respectively indicating existence and non-existence of the phrases in the SQL statements 10 at offsets (occurrence positions). That is, the basic index 132 refers to bitmaps that are obtained by indexing of existence or non-existence of the phrases included in the SQL statements 10 to be encoded at each offset (occurrence position). For example, if a phrase exists at a certain occurrence position in the SQL statements 10, a state, “ON”, for example, an occurrence bit indicating a binary number, “1”, is set as existence or non-existence thereof at an offset (occurrence position) corresponding to the occurrence position. If the phrase does not exist at a certain occurrence position in text data, a state, “OFF”, for example, a binary number, “0”, is set as existence or non-existence at an offset (occurrence position) corresponding to the occurrence position. In description of this embodiment, when the occurrence bit is “0”, the notation, “0”, may be omitted. A phrase ID of a phrase, for example, is adopted as a pointer that specifies the phrase. The phrase ID may be the phrase itself, or may be a code of that phrase. The code of the phrase refers to a code that has been encoded (an encoded code), and corresponds to, for example, a static code.

For example, as illustrated in FIG. 2, an X-axis of the basic index 132 represents the offset (occurrence position), and a Y-axis represents the phrase ID. That is, each bitmap included in the basic index 132 indicates existence or non-existence of a phrase represented by a phrase ID at each offset (occurrence position). The X-axis of the basic index 132 is an example of a first axis. Further, as illustrated in FIG. 2, the Y-axis is divided into a reserved word layer where a phrase is registered when the phrase is a reserved word, and a variable information layer where a phrase is registered when the phrase is a piece of variable information. Each bitmap included in the basic index 132 will be referred to as a “basic bitmap”.

In FIG. 2, since the reserved word, “FROM”, occurs at a fourth position in the SQL statements 10 to be encoded, the state, “ON”, that is, an occurrence bit indicating the binary number, “1”, is set at a fourth bit occurrence position of a basic bitmap corresponding to the reserved word, “FROM”, which has been registered in the reserved word layer. Since the piece of variable information, “in1”, occurs at a fifth position in the SQL statements 10 to be encoded, the state, “ON”, that is, an occurrence bit indicating the binary number, “1”, is set at a fifth bit occurrence position of a basic bitmap corresponding to the piece of variable information, “in1”, which has been registered in the variable information layer.

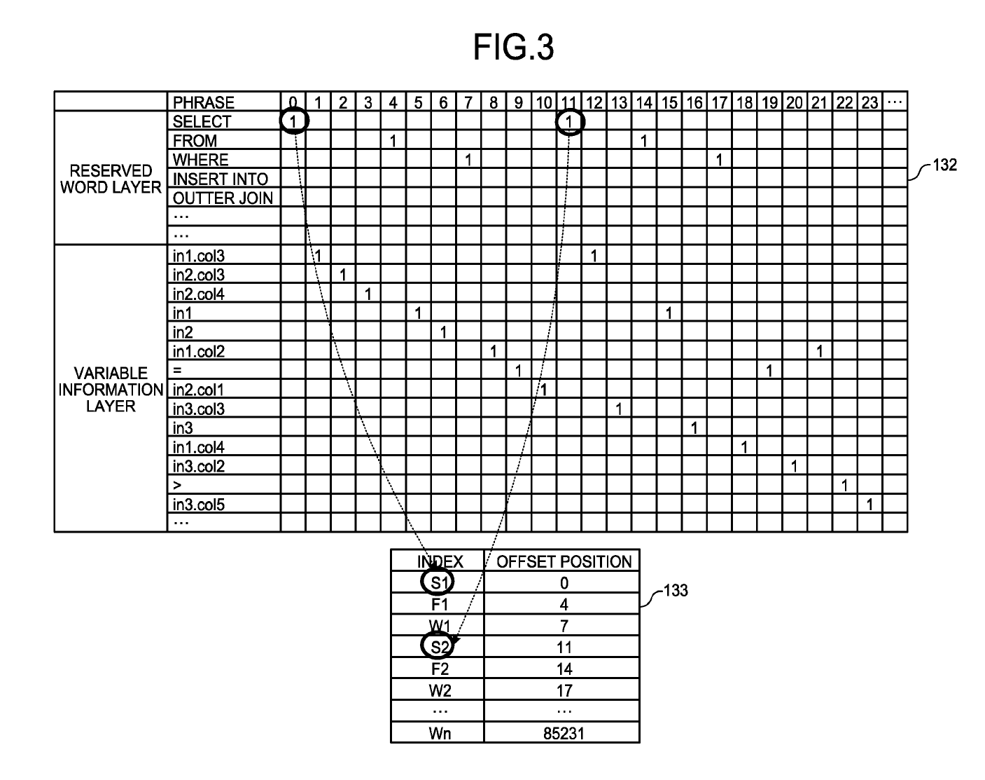

The address table 133 in FIG. 1 is a table where offset positions of reserved words in encoded data 11 are registered. Next, details of the address table 133 will be described by reference to FIG. 3.

FIG. 3 is a diagram illustrating an example of a configuration of the address table 133 according to the embodiment. The address table 133 is a table where indices of reserved words included in the SQL statements 10 to be encoded are registered in association with offset positions of these reserved words. In the indices described in the address table 133: a notation, “S1”, represents the reserved word, “SELECT”, which occurs firstly; a notation, “F1”, represents the reserved word, “FROM”, which occurs firstly; and a notation, “W1”, represents the reserved word, “WHERE”, which occurs firstly.

In the basic bitmap of the basic index 132 for the reserved word, “SELECT”, the first occurrence bit indicating “1” occurs at the 0-th bit, and thus the offset position of the index, “S1”, is set to “0”. In the basic bitmap of the basic index 132 for the reserved word, “SELECT”, the second occurrence bit indicating “1” occurs at the 11-th bit, and thus the offset position of the index, “S2”, is set to “11”. Indices for the reserved word, “FROM”, and the reserved word, “WHERE”, are also set similarly, as illustrated by the example in FIG. 3.

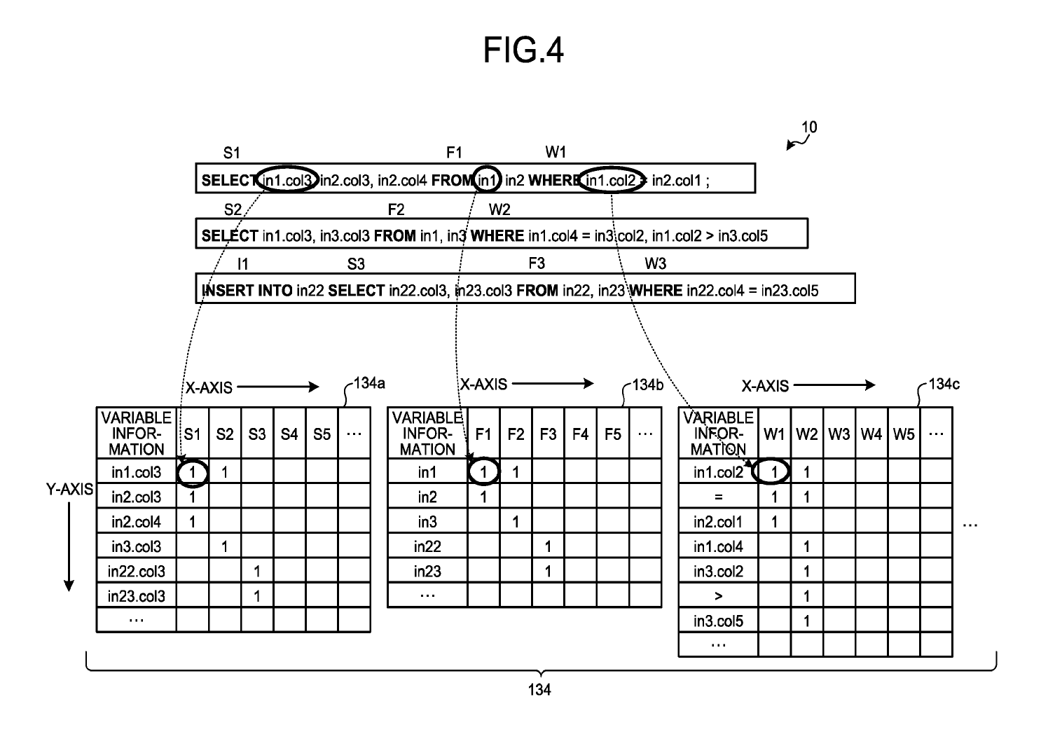

The upper hierarchical layer index group 134 in FIG. 1 is a group of index information having second axes superordinate to the first axis of the basic index 132. Next, details of the upper hierarchical layer index group 134 will be described while reference is made to FIG. 4.

FIG. 4 is a diagram illustrating an example of a configuration of the upper hierarchical layer index group 134 according to the embodiment. As illustrated by the example in FIG. 4, the upper hierarchical layer index group 134 is formed as a group of plural upper hierarchical layer indexes 134a, 134b, 134c, . . . corresponding to the reserved words, the number of the plural upper hierarchical layer indexes 134a, 134b, 134c, . . . being the number of types of the reserved words described in the SQL statements 10. For example: the upper hierarchical layer index 134a corresponds to the reserved word, “SELECT”; the upper hierarchical layer index 134b corresponds to the reserved word, “FROM”; and the upper hierarchical layer index 134c corresponds to the reserved word, “WHERE”.

These upper hierarchical layer indexes 134a . . . each have a second axis superordinate to the first axis, which is the X-axis (offset (occurrence position)) of the basic index 132. The second axis is an axis where the indices of each reserved word registered in the address table 133 has been made superordinate (summarized) in one bit. For example, in the upper hierarchical layer index 134a corresponding to the reserved word, “SELECT”, its X-axis serving as a second axis represents the indices S1, S2, . . . registered in the address table 133. In the upper hierarchical layer index 134b corresponding to the reserved word, “FROM”, its X-axis serving as a second axis represents the indices F1, F2, . . . registered in the address table 133. In the upper hierarchical layer index 134c corresponding to the reserved word, “WHERE”, its X-axis serving as a second axis represents the indices W1, W2, . . . registered in the address table 133. That is, the X-axes of the upper hierarchical layer indexes 134a, are an example of the second axes. Further, Y-axes of the upper hierarchical layer indexes 134a, . . . represent variable information serving as targets of the reserved words.

For example, if the piece of variable information, “in1.col3”, has been described as a target of the first reserved word, “SELECT”, the state, “ON”, that is, an occurrence bit indicating the binary number, “1”, is set at the occurrence position of the item, “S1”, in the basic bitmap of the piece of variable information, “in1.col3”, in the upper hierarchical layer index 134a. If the piece of variable information, “in1”, has been described as a target of the first reserved word, “FROM”, the state, “ON”, that is, an occurrence bit indicating the binary number, “1”, is set at the occurrence position of the item, “F1”, in the basic bitmap of the piece of variable information, “in1”, in the upper hierarchical layer index 134b. If the piece of variable information, “in1.col2”, has been described as a target of the first reserved word, “WHERE”, the state, “ON”, that is, an occurrence bit indicating the binary number, “1”, is set at the occurrence position of the item, “W1”, in the basic bitmap of the piece of variable information, “in1.col2”, in the upper hierarchical layer index 134c. Every time a piece of variable information in the SQL statements 10 is encoded, an occurrence bit in the upper hierarchical layer indexes 134a, . . . is set at the occurrence position of the index corresponding to that piece of variable information.

Search Processing According to Embodiment

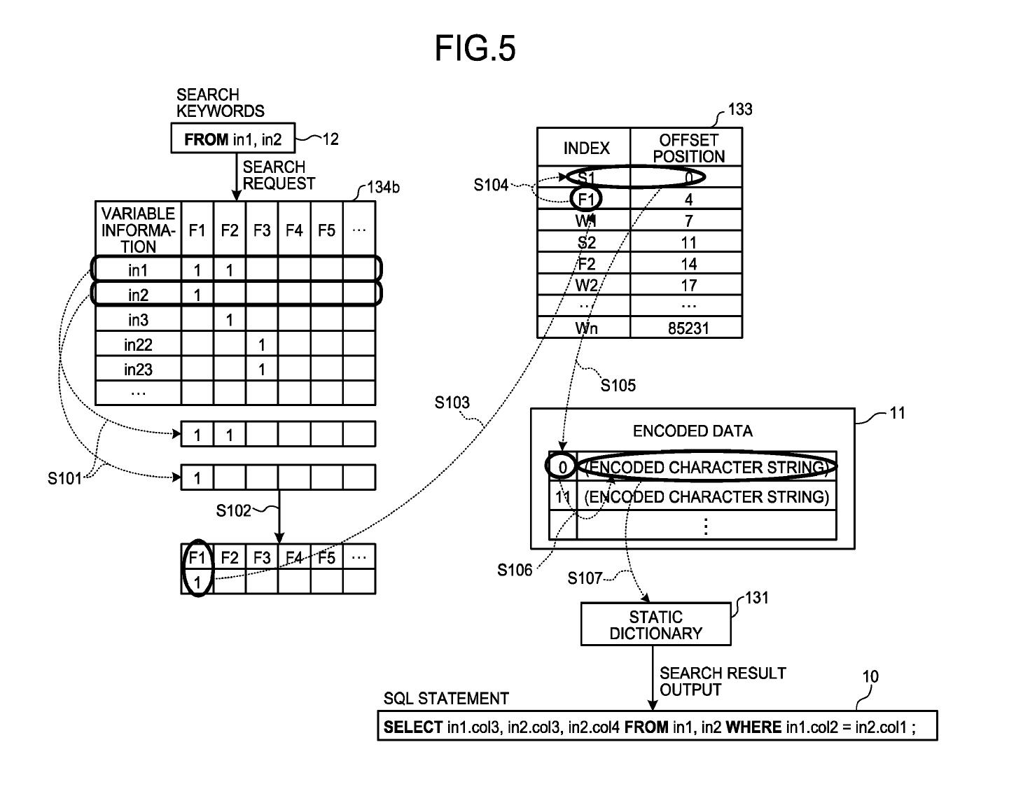

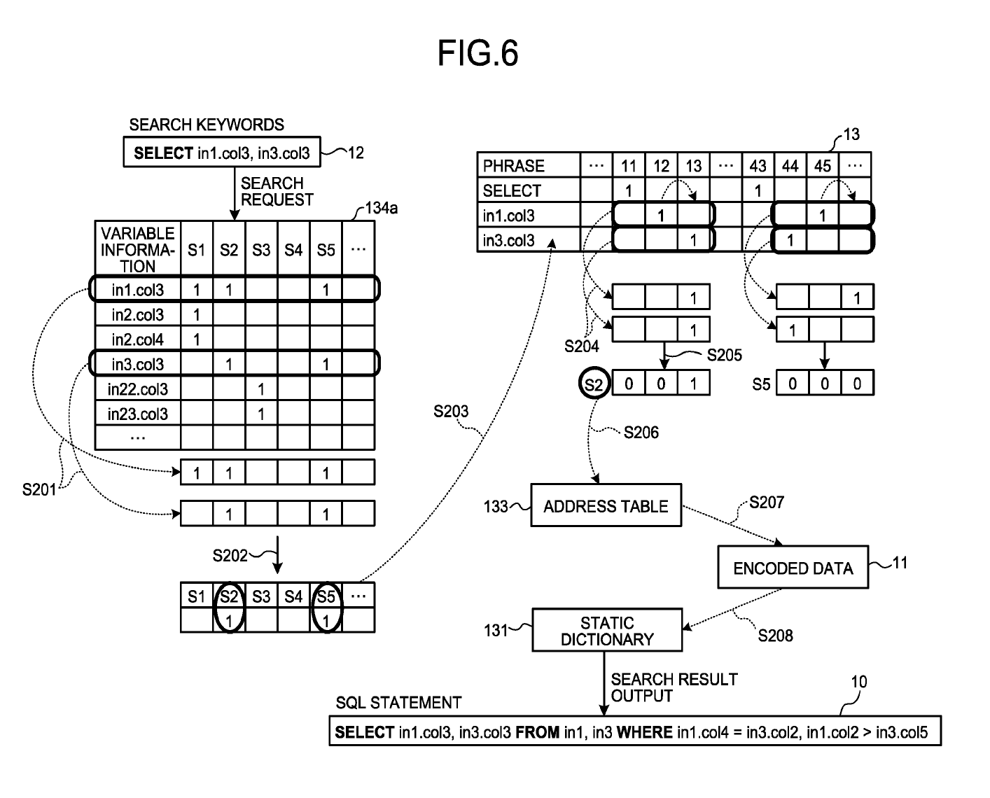

Next, details of search processing by use of the basic index 132, the address table 133, and the upper hierarchical layer index group 134, which have been described thus far, will be described while reference is made to FIG. 5 and FIG. 6. FIG. 5 is a diagram illustrating an example of search processing for a SQL statement 10, according to an embodiment. As illustrated by the example in FIG. 5, in the search processing, the following processing is performed, based on contents of search keywords 12, and contents of the address table 133 and an upper hierarchical layer index group 134.

A search request receiving unit 121 receives, as illustrated by the example in FIG. 5, the search keywords 12 with respect to the encoded data 11. The contents of the search keywords 12 in this example are the control statement, “FROM inl, in2”. A search processing unit 122 firstly refers to the upper hierarchical layer index 134b corresponding to the reserved word, “FROM”, included in the search keywords 12, among the upper hierarchical layer index group 134, and extracts the basic bitmap of the piece of variable information, “in1” and the basic bitmap of the piece of the piece of variable information, “in2”, which are included in the search keywords 12 (Step S101).

Subsequently, the search processing unit 122 performs an AND bitwise operation between the basic bitmap of the piece of variable information, “in1”, and the basic bitmap of the piece of variable information, “in2”, which have been extracted (Step S102). A result of this AND bitwise operation indicates a position of the reserved word, “FROM”, targeting the pieces of variable information, “in1” and “in2”. The search processing unit 122 then determines whether or not there is an index with its occurrence bit indicating “1”, and extracts any index with its occurrence bit indicating “1”. In this example, since the occurrence bit of the index, “F1”, is “1”, and the occurrence bits of all of the other indices F2, F3, . . . are “0”, the index, “F1”, is extracted.

The search processing unit 122 then determines whether or not the pieces of variable information targeted by the reserved word described in the search keywords 12 are in no particular order. In other words, the search processing unit 122 determines whether or not the order of the pieces of variable information targeted by the reserved word described in the search keywords 12 has significance. In the example of FIG. 5, since the pieces of variable information targeted by the reserved word, “FROM”, are in no particular order (that is, the order between the pieces of variable information, “in1” and “in2”, has no significance), the search processing unit 122 performs narrowing down, based on the index, “F1”, that has been extracted ahead, to obtain the corresponding index, “F1”, from the address table 133 (Step S103). Whether or not the order of pieces of variable information targeted by each reserved word has significance may be stored beforehand in the storage unit 130.

Subsequently, the search processing unit 122 obtains, from the address table 133, an offset position (in this case, the offset position, “0”) of a start position (in this case, the index, “S1”) of a SQL statement 10 corresponding to the index, “F1”, obtained by the narrowing down (Step S104). Based on the obtained offset position of the start position of the SQL statement 10, the search processing unit 122 then refers to the encoded data 11 (Step S105), and extracts an encoded character string corresponding thereto (hereinafter, also referred to as the encoded character string) (Step S106).

Subsequently, the search processing unit 122 decodes, based on the static dictionary 131, the extracted encoded character string (Step S107). Lastly, a search result output unit 123 outputs the SQL statement 10 that is a search result that has been decoded.

The above described search processing according to the embodiment enables a fast search with the search keywords 12 from the encoded data 11, by a search area being narrowed down through use of the upper hierarchical layer index group 134 and an address table 133.

FIG. 6 is a diagram illustrating another example of the search processing for a SQL statement 10, according to the embodiment. By reference to FIG. 6, an example of a case where pieces of variable information targeted by a reserved word described in the search keywords 12 are not in no particular order (that is, the description order of the pieces of variable information has significance) will be described. A case where a search related to the reserved word, “SELECT”, is performed, the reserved word targeting pieces of variable information having significance in the description order of the pieces of variable information.

The search request receiving unit 121 receives, as illustrated by the example in FIG. 6, the search keywords 12 with respect to the encoded data 11. Contents of the search keywords 12 in this example are the control statement, “SELECT in1.col3, in3.col3”. The search processing unit 122 firstly refers to the upper hierarchical layer index 134a corresponding to the reserved word, “SELECT”, among the upper hierarchical layer index group 134, and extracts the basic bitmap of the piece of variable information, “in1.col.3” and the basic bitmap of the piece of variable information, “in3.col3”, which are included in the search keywords 12 (Step S201).

Subsequently, the search processing unit 122 performs an AND bitwise operation between the basic bitmap of the piece of variable information, “in1.co.l3”, and the basic bitmap of the piece of variable information, “in3.col.3”, which have been extracted (Step S202). A result of this AND bitwise operation indicates positions of the reserved word, “SELECT”, targeting the pieces of variable information, “in1.col3” and “in3.col3”. The search processing unit 122 then determines whether there is an index with its occurrence bit indicating “1”, and extracts any index with its occurrence bit indicating “1”. In this example, since the occurrence bit of the index, “S2”, and the occurrence bit of the index, “S5”, are “1”, and the occurrence bits of all of the other indices S1, S3, S4, . . . are “0”, the indices, “S2” and “S5”, are extracted.

The search processing unit 122 then determines whether or not the pieces of variable information targeted by the reserved word described in the search keywords 12 are in no particular order. In the example of FIG. 6, since the pieces of variable information targeted by the reserved word, “SELECT”, are not in no particular order, the search processing unit 122 extracts, from the basic index 132, basic bitmaps of all of the phrases (in the example of FIG. 6, the reserved word, “SELECT”, and the pieces of variable information, “in1.col3” and “in3.col3”) included in the search keywords 12, and generates an inverted index 13 (Step S203). Further, the search processing unit 122 extracts, from the generated inverted index 13, bitmaps of the pieces of variable information, “in1.col3” and “in3.col3”, that are in target sections of the indices, “S2”, and “S5”, extracted in Step S202 (Step S204). At Step S204, the bitmap of the piece of variable information described ahead in the search keywords 12 (in the example of FIG. 6, the piece of variable information, “in1.col3”) is extracted after being shifted rightward by one bit.

Subsequently, the search processing unit 122 performs an AND bitwise operation between the basic bitmap of the piece of variable information, “in1.co.l3”, and the basic bitmap of the piece of variable information, “in3.col.3”, which have been extracted, and from a result of this AND bitwise operation, extracts an index having “1” in its occurrence bits (Step S205). In the example of FIG. 6, while the index, “S2”, has “1” in the occurrence bits; the index, “S5”, has no “1” in the occurrence bits and all of the occurrence bits are “0”. Therefore, through Step S205, the index, “S2”, is extracted. Subsequently, the search processing unit 122 performs narrowing down, based on the extracted index, “S2”, to obtain the corresponding index, “S2”, from the address table 133 (Step S206). Since the processing at Step S206 is similar to that at Step S103 described with respect to the example in FIG. 5, detailed description thereof will be omitted.

Subsequently, the search processing unit 122 obtains, from the address table 133, an offset position of a start position of a SQL statement 10 corresponding to the index, “S2”, which has been obtained by the narrowing down. Based on the obtained offset position of the start position of the SQL statement 10, the search processing unit 122 then refers to the encoded data 11, and extracts an encoded character string corresponding thereto (Step S207). Since the processing at Step S207 is similar to that at Steps S105 and S106 described with respect to the example in FIG. 5, detailed description thereof will be omitted.

Subsequently, the search processing unit 122 decodes, based on the static dictionary 131, the extracted encoded character string (Step S208). Lastly, the search result output unit 123 outputs the SQL statement 10 that is a search result that has been decoded.

The above described search processing according to the embodiment enables a fast search with the search keywords 12 from the encoded data 11, by dynamic extraction of the inverted index 13 from the basic index 132, even in a case where the search is performed with respect to a reserved word having significance in the description order of the pieces of variable information.

Each of the encoding unit 110 and the search unit 20 illustrated in FIG. 1 has an internal memory for storing therein a program prescribing therein various processing procedures, and control data, and executes various types of processing by using the program and control data. Each of the encoding unit 110 and the search unit 120 corresponds to an integrated electronic circuit, such as, for example, an application specific integrated circuit (ASIC), or a field programmable gate array (FPGA). Or, each of the encoding unit 110 and the search unit 120 corresponds to an electronic circuit, such as a central processing unit (CPU) or a micro processing unit (MPU).

The encoding unit 110 is a processing unit that executes encoding processing illustrated in FIG. 2 to FIG. 4. The encoding unit 110 has a file reading unit 111, a reserved word and variable information obtaining unit 112, a basic index generating unit 113, an encoding processing unit 114, an upper hierarchical layer index generating unit 115, and a file writing unit 116. The file reading unit 111 is an example of an input unit. The basic index generating unit 113 is an example of a first index generating unit. The upper hierarchical layer index generating unit 115 is an example of a second index generating unit.

The file reading unit 111 loads the SQL statements 10 to be encoded, into a storage area.

The reserved word and variable information obtaining unit 112 obtains a reserved word or piece of variable information from the SQL statements 10. For example, the reserved word and variable information obtaining unit 112 performs lexical analysis on the SQL statements 10 loaded into the storage area. The reserved word and variable information obtaining unit 112 obtains the reserved word or piece of variable information that is a result of the lexical analysis, in order from the head of the SQL statements 10. The reserved word and variable information obtaining unit 112 outputs the reserved word or piece of variable information obtained, in association with its occurrence position in the SQL statements 10, to the basic index generating unit 113. The reserved word and variable information obtaining unit 112 outputs the obtained reserved word or piece of variable information, to the encoding processing unit 114.

The basic index generating unit 113 generates the basic index 132. For example, the basic index generating unit 113 extracts, from the basic index 132, a basic bitmap corresponding to a reserved word output from the reserved word and variable information obtaining unit 112. The basic index generating unit 113 sets an occurrence bit at a bit of the extracted basic bitmap, the bit corresponding to the occurrence position of that reserved word in the SQL statements 10. Further, the basic index generating unit 113 extracts, from the basic index 132, a basic bitmap corresponding to a piece of variable information output from the reserved word and variable information obtaining unit 112. The basic index generating unit 113 sets an occurrence bit at a bit of the extracted basic bitmap, the bit corresponding to the occurrence position of that piece of variable information in the SQL statements 10.

The encoding processing unit 114 encodes a reserved word or piece of variable information. For example, the encoding processing unit 114 encodes a reserved word output from the reserved word and variable information obtaining unit 112, into a static code that has been registered in the static dictionary 131. Further, the encoding processing unit 114 encodes a piece of variable information output from the reserved word and variable information obtaining unit 112, into a static code that has been registered in the static dictionary 131.

Based on the contents of the basic index 132 and the address table 133, the upper hierarchical layer index generating unit 115 generates the upper hierarchical layer index group 134 that is a group of the upper hierarchical layer indexes 134a, . . . having the second axes superordinate to the first axis. For example, the upper hierarchical layer index generating unit 115 registers the indices of the generated address table 133, along the horizontal axes of the upper hierarchical layer indexes 134a, etc. The upper hierarchical layer index generating unit 115 registers the pieces of variable information, along the vertical axes of the upper hierarchical layer indexes 134a, . . . , and sets an occurrence bit indicating “1” at bits corresponding to the occurrence positions of the pieces of variable information in the SQL statements 10.

The file writing unit 116 stores an encoded code that has been encoded by the encoding processing unit 114, in the encoded data 11.

The search unit 120 is a processing unit that executes the search processing illustrated in FIG. 5 and FIG. 6. The search unit 120 has the search request receiving unit 121, the search processing unit 122, and the search result output unit 123.

The search request receiving unit 121 receives a request for a search through the encoded data 11. For example, the search request receiving unit 121 receives a search request that is a reserved word string to be searched, or a variable information string to be searched. The search request receiving unit 121 may receive a search request that is a phrase string including a combination of a reserved word and a piece of variable information.

By using the basic index 132, the address table 133, and the upper hierarchical layer index group 134, the search processing unit 122 performs a search through the encoded data 11, the search corresponding to a reserved word string to be searched or a variable information string to be searched, which serves as a search request.

For example, among the upper hierarchical layer index group 134, the search processing unit 122 firstly extracts a basic bitmap of each piece of variable information to be searched, by referring to the upper hierarchical layer indexes 134a, . . . corresponding to a reserved word to be searched. Subsequently, the search processing unit 122 performs an AND bitwise operation on the extracted basic bitmaps of the pieces of variable information. The search processing unit 122 then determines whether or not there is any index with its occurrence bit indicating “1”, and extracts any index with its occurrence bit indicating “1”.

The search processing unit 122 then determines whether or not the pieces of variable information targeted by the reserved word to be searched are in no particular order (that is, the order of the targeted pieces of variable information has no significance). If the pieces of variable information targeted by the reserved word to be searched are in no particular order, that is, if the order of the pieces of variable information targeted has no significance; based on the index that has been extracted ahead, the search processing unit 122 performs narrowing down to obtain the corresponding index from the address table 133.

Subsequently, the search processing unit 122 obtains, from the address table 133, an offset position of a start position of the SQL statement 10 corresponding to the index obtained by the narrowing down. Based on the obtained offset position of the start position of the SQL statement 10, the search processing unit 122 then extracts an encoded character string corresponding thereto, by referring to the encoded data 11. Subsequently, the search processing unit 122 decodes, based on the static dictionary 131, the extracted encoded character string.

On the contrary, if the pieces of variable information targeted by the reserved word to be searched are not in no particular order, that is, if the order of the targeted pieces of variable information has significance; the search processing unit 122 extracts, from the basic index 132, basic bitmaps of all of the phrases included in the search keywords 12, and generates the inverted index 13. Further, the search processing unit 122 extracts, from the inverted index 13 generated, bitmaps of pieces of variable information in target sections of the index that has been extracted ahead. Upon this extraction, the bitmap of the piece of variable information that is described ahead in the search keywords 12 is extracted after being shifted rightward by one bit.

Subsequently, the search processing unit 122 performs an AND bitwise operation between the extracted basic bitmaps of the pieces of variable information, and from a result of this AND bitwise operation, extracts an index having an occurrence bit indicating “1”. Subsequently, based on the extracted index, the search processing unit 122 performs narrowing down to obtain the corresponding index from the address table 133.

Subsequently, the search processing unit 122 obtains, from the address table 133, an offset position of a start position of the SQL statement 10 corresponding to the index obtained by the narrowing down. Based on the obtained offset position of the start position of the SQL statement 10, the search processing unit 122 extracts an encoded character string corresponding thereto, by referring to the encoded data 11. Subsequently, the search processing unit 122 decodes, based on the static dictionary 131, the extracted encoded character string.

The search result output unit 123 outputs a search result. For example, if the search processing unit 122 determines that a search target is available, the search result output unit 123 outputs, as a search result, that a search target is available. If the search processing unit 122 determines that a search target is not available, the search result output unit 123 outputs, as a search result, that a search target is not available.

Processing Procedure of Index Generating Process According to Embodiment

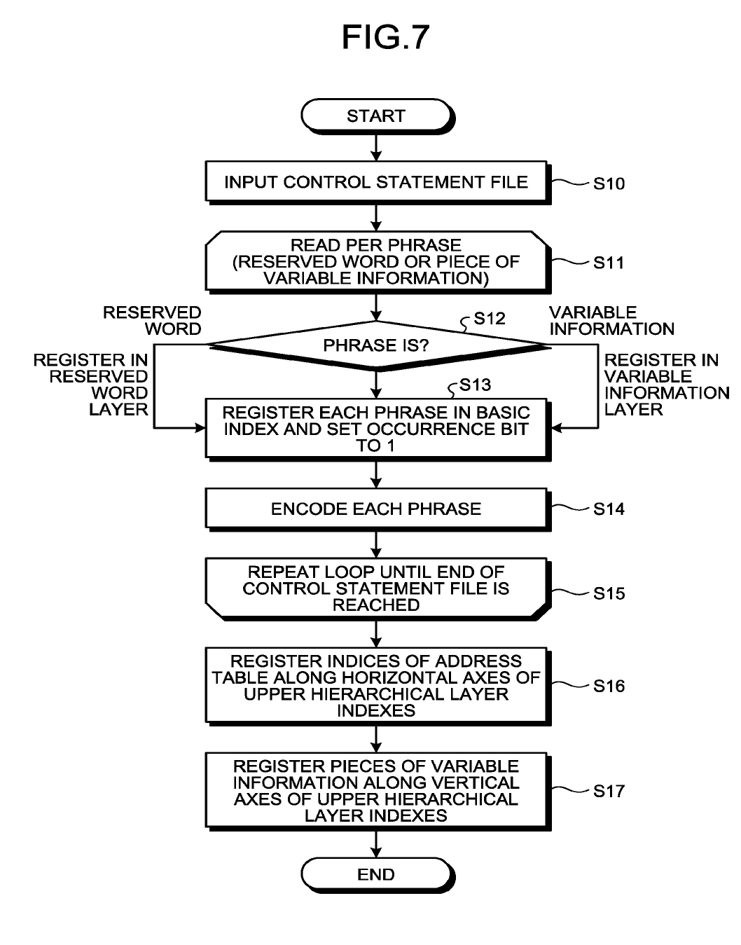

A processing procedure by the encoding unit 110 illustrated in FIG. 1 will now be described by reference to FIG. 7. FIG. 7 is a diagram illustrating an example of a flow of an index generating process according to an embodiment. Firstly, after executing preprocessing (for example, securing various storage areas in the storage unit 130), the file reading unit 111 inputs therein a control statement file to be encoded (for example, the SQL statements 10) (Step S10).

Subsequently, the reserved word and variable information obtaining unit 112 reads, from a storage area for reading, the control statement file per phrase (reserved word or piece of variable information) (Step S11). For example, the reserved word and variable information obtaining unit 112 performs lexical analysis on the SQL statements 10 stored in the storage area for reading, and obtains a phrase (reserved word or piece of variable information) resulting from the lexical analysis, in order from the head of the SQL statements 10.

Subsequently, the reserved word and variable information obtaining unit 112 determines whether the phrase obtained is a reserved word or a piece of variable information (Step S12). If the reserved word and variable information obtaining unit 112 determines that the obtained phrase is a reserved word (“reserved word” at Step S12), the basic index generating unit 113 registers the obtained reserved word in the reserved word layer of the basic index 132, and sets an occurrence bit indicating “1” at a bit corresponding to its occurrence position (Step S13). On the contrary, if the reserved word and variable information obtaining unit 112 determines that the obtained phrase is a piece of variable information (“variable information” at Step S12), the basic index generating unit 113 registers the obtained piece of variable information in the variable information layer of the basic index 132, and sets an occurrence bit indicating “1” at a bit corresponding to its occurrence position (Step S13).

Subsequently, the encoding processing unit 114 encodes each phrase obtained, into a static code that has been registered in the static dictionary 131 (Step S14). The loop from Step S11 is repeated until the end of the control statement file is reached (Step S15). Concurrently with the processing in the loop, the basic index generating unit 113 generates the address table 133. Further, if a phrase obtained has been registered in the basic index 132 already, the basic index generating unit 113 extracts, from the basic index 132, a basic bitmap corresponding to the obtained phrase, and sets an occurrence bit indicating “1” at a bit of the extracted basic bitmap, the bit corresponding to the occurrence position of the obtained phrase in the control statement file.

When the end of the control statement file is reached, the upper hierarchical layer index generating unit 115 registers the indices of the address table 133 generated, along the horizontal axes of the upper hierarchical layer indexes 134a, . . . (Step S16). The upper hierarchical layer index generating unit 115 then registers the pieces of variable information along the vertical axes of the upper hierarchical layer indexes 134a, . . . , sets occurrence bits indicating “1” (Step S17), and ends processing.

Processing Procedure of Search Processing According to Embodiment

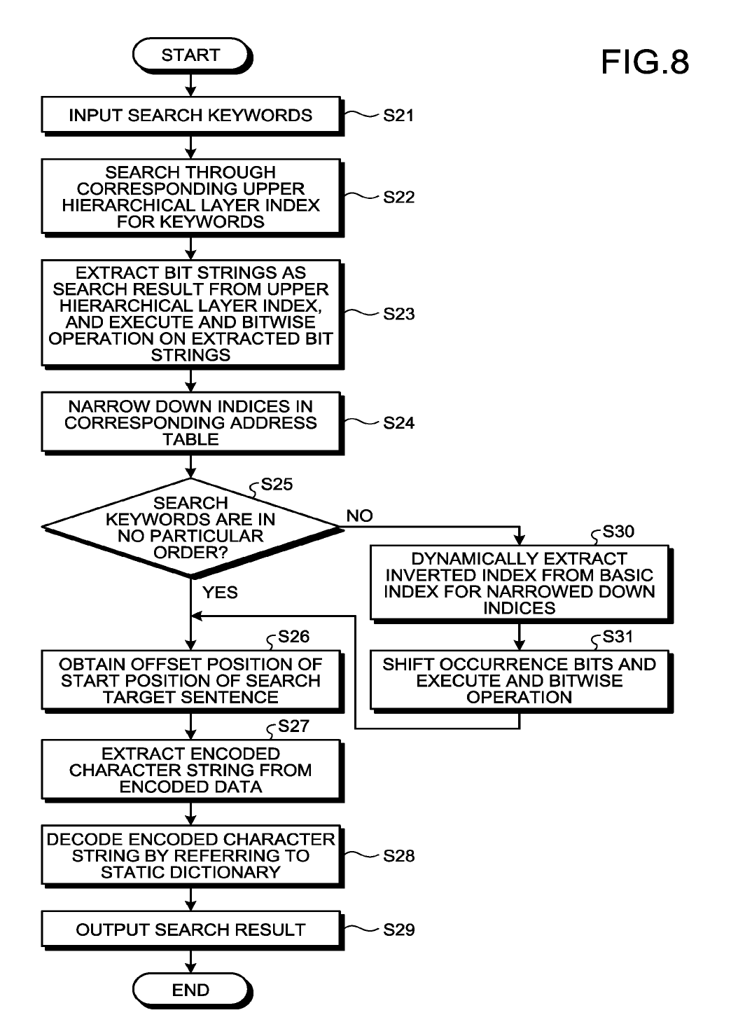

A processing procedure by the search unit 120 illustrated in FIG. 1 will now be described by reference to FIG. 8. FIG. 8 is a diagram illustrating an example of a flow of search processing according to an embodiment.

Firstly, the search keywords 12 are input to the search request receiving unit 121 (Step S21). Subsequently, the search processing unit 122 searches for the search keywords 12, in the upper hierarchical layer indexes 134a, . . . corresponding thereto (Step S22). The search processing unit 122 extracts, from the upper hierarchical layer indexes 134a, . . . , bit strings that are a result of the search, and executes an AND bit operation on the extracted bit strings (Step S23). Subsequently, the search processing unit 122 performs narrowing down to obtain any corresponding index from the address table 133 (Step S24).

The search processing unit 122 then determines whether or not the pieces of variable information targeted by the reserved word described in the search keywords 12 are in no particular order (Step S25). If the search processing unit 122 determines that the corresponding pieces of variable information are in no particular order (“YES” at Step S25), the search processing unit 122 obtains, from the address table 133, an offset position of a start position of a search target statement corresponding to the index obtained by the narrowing down (Step S26). Based on the obtained offset position, the search processing unit 122 then extracts an encoded character string from the encoded data 11 (Step S27). Subsequently, the search processing unit 122 decodes the extracted encoded character string by referring to the static dictionary 131 (Step S28). Lastly, the search result output unit 123 outputs the coded character string that has been decoded serving as a search result (Step S29), and ends processing.

On the contrary, if the search processing unit 122 determines that the pieces of variable information targeted are not in no particular order (“NO” at Step S25), the search processing unit 122 dynamically extracts the inverted index 13 from the basic index 132 for the indices that have been obtained by the narrowing down (Step S30). The search processing unit 122 then extracts, from the extracted inverted index 13, bitmaps of pieces of variable information in target sections of indices that have been extracted ahead while shifting occurrence bits, and executes an AND bitwise operation on the extracted bitmaps of the pieces of variable information (Step S31). The search processing unit 26 then proceeds to the processing of Step S26.

### Effects of Embodiments

According to the above described embodiments, the encoding unit 110 inputs therein control statements (SQL statements 10) including plural phrases and having contents that change according to description positions of the plural phrases. The encoding unit 110 generates the first index information (basic index 132) related to positional information of each phrase in the control statements (SQL statements 10). The encoding unit 110 then generates, from the first index information (basic index 132), the second index information group (upper hierarchical layer index group 134) related to phrases targeted by each reserved word included in the control statements (SQL statements 10). According to this configuration, by generating, from the basic index 132, an upper hierarchical layer index for each reserved word included in the SQL statements 10, the encoding unit 110 enables search processing through the SQL statements 10 for determination of a search target to be speeded up. That is, by narrowing down a search area by use of the upper hierarchical layer index group 134 and the address table 133, the search unit 120 is able to search for the search keywords 12 from the encoded data 11 at high speed.

Further, according to the above described embodiments, each set of second index information included in the second index information group is index information having an axis for a reserved word and superordinate to the first axis related to the offset positions in the first index information. The second index information group corresponds to the upper hierarchical layer index group 134, the sets of second index information correspond to the upper hierarchical layer indexes 134a, . . . , and the first index information corresponds to the basic index 132. According to this configuration, the search unit 120 is able to perform a search with less computation, by performing the search at granularity of the reserved word level.

Further, according to the above described embodiments, the second axes respectively include the reserved words included in the plural phrases and the phrases (pieces of variable information) targeted by the reserved words. According to this configuration, by extracting targeted basic bitmaps from the reserved word layer and the variable information layer in the basic index 132, the search processing unit 122 is able to generate the inverted index 13 efficiently.

### Other Modes Related to Embodiments

Hereinafter, some of modified examples of the above described embodiments will be described. Not only the following modified examples but also other design changes may be made as appropriate without departing from the spirit of the present invention.

For example, according to the above described embodiments, the control statement file is the SQL statements 10, but the control statement file may be control statements that are not SQL statements.

In addition, the processing procedures, the control procedures, the specific names, and the information including the various data and parameters, which have been described with respect to the embodiments, may be arbitrarily modified unless otherwise particularly stated.

Hardware Configuration of Information Processing Apparatus

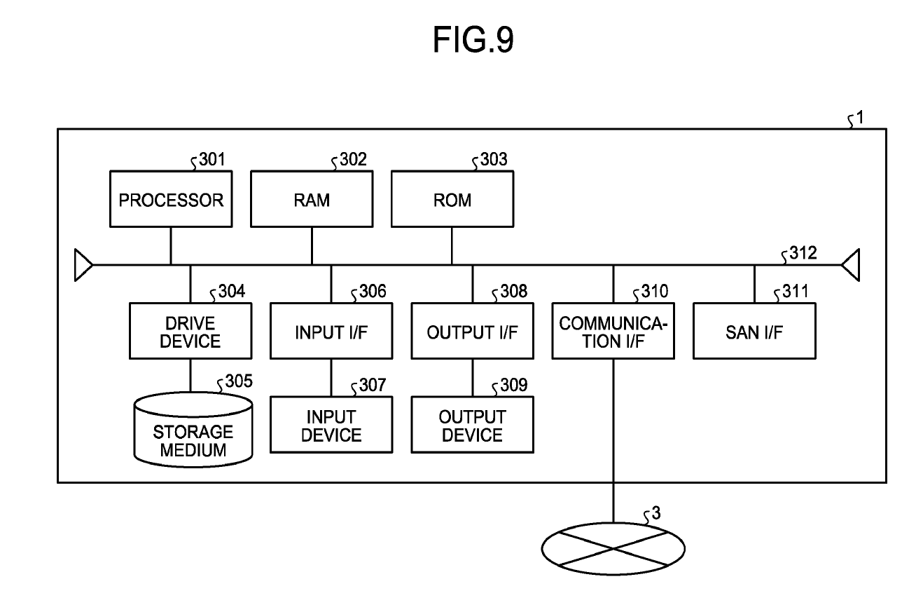

Hardware and software used in the above described embodiments will be described below. FIG. 9 is a diagram illustrating an example of a hardware configuration of a computer 1. The computer 1 includes, for example, a processor 301, a random access memory (RAM) 302, a read only memory (ROM) 303, a drive device 304, a storage medium 305, an input interface (I/F) 306, an input device 307, an output interface (I/F) 308, an output device 309, a communication interface (I/F) 310, a storage area network (SAN) interface (I/F) 311, and a bus 312. These hardware devices are connected to one another via the bus 312.

The RAM 302 is a readable and writable memory device; and for example, a semiconductor memory, such as a static RAM (SRAM) or a dynamic RAM (DRAM), or, if not a RAM, a flash memory, may be used as the RAM 302. The ROM 303 may be a programmable ROM (PROM). The drive device 304 is a device that performs at least one of reading and writing of information that has been recorded in the storage medium 305. The storage medium 305 stores therein information that has been written by the drive device 304. The storage medium 305 is, for example: a hard disk; a flash memory, such as a solid state drive (SSD); or a storage medium, such as a compact disc (CD), a digital versatile disc (DVD), or a Blu-ray Disc. Further, for example, the computer 1 has, for each of plural types of storage media, the drive device 304 and the storage medium 305, provided therein.

The input interface 306 is a circuit, which is connected to the input device 307, and transmits input signals received from the input device 307, to the processor 301. The output interface 308 is a circuit, which is connected to the output device 309, and causes the output device 309 to execute output according to instructions from the processor 301. The communication interface 310 is a circuit that executes control of communication via the network 3. The communication interface 310 is, for example, a network interface card (NIC). The SAN interface 311 is a circuit that executes control of communication with a storage device connected to the computer 1 via a storage area network. The SAN interface 311 is, for example, a host bus adapter (HBA).

The input device 307 is a device that transmits input signals according to operations. The input device 307 is, for example: a key device, such as a keyboard or buttons that are installed in the body of the computer 1; and a pointing device, such as a mouse or a touch panel. The output device 309 is a device that outputs information according to control by the computer 1. The output device 309 is, for example, an image output device (display device), such as a display, or a sound output device, such as a speaker. Further, for example, an input and output device, such as a touch screen, may be used as the input device 307 and the output device 309. Furthermore, the input device 307 and the output device 309 may be integrated with the computer 1, or may be not included in the computer 1. For example, the input device 307 and the output device 309 may be a device that is connected to the computer 1 from outside.

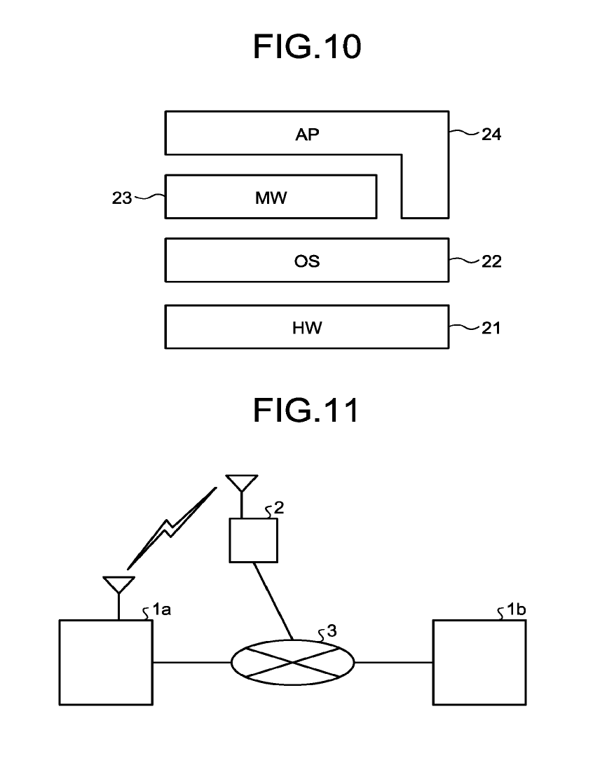

For example, the processor 301 loads a program stored in the ROM 303 or storage medium 305, into the RAM 302, and executes the processing of the encoding unit 110 and the search unit 120 according to a procedure of the program loaded. The RAM 302 is used as a work area of the processor 301 in this processing. Functions of the storage unit 130 are realized by: the ROM 303 and the storage medium 305 storing therein program files (an application program 24, middleware 23, and an OS 22, which will be described later) and data files (for example, the static dictionary 131, the basic index 132, the address table 133, and the upper hierarchical layer index group 134); and the RAM 302 being used as the work area of the processor 301. The program loaded by the processor 301 will now be described by use of FIG. 10.

FIG. 10 is a diagram illustrating an example of a configuration of the program that runs on the computer. The operating system (OS) 22 that executes control of a hardware group (HW) 21 (301 to 312) illustrated in FIG. 9 runs on the computer 1. By the processor 301 operating by a procedure according to the OS 22, and control and management of the hardware group (HW) 21 being executed; processing according to the application program (AP) 24 and middleware (MW) 23 is executed by the hardware group 21. Further, on the computer 1, the middleware (MW) 23 or application program (AP) 24 is loaded into the RAM 302 and executed by the processor 301.

When an encoding function is called, the processor 301 executes processing based on at least a part of the middleware 23 or application program 24, and thereby (the hardware group 21 is controlled by the processing based on the OS 22 and) the functions of the encoding unit 110 and the search unit 120 are realized. The encoding function and search function may be included in the application program 24 itself, or may be a part of the middleware 23 that is executed by being called according to the application program 24.

FIG. 11 is a diagram illustrating an example of a configuration of apparatuses in a system according to an embodiment. The system in FIG. 11 includes a computer 1a, a computer 1b, a base station 2, and a network 3. The computer 1a is connected, via at least one of wireless connection and wired connection, to the network 3 that is connected to the computer 1b.

The encoding unit 110 and search unit 120 illustrated in FIG. 1 may be included in any of the computer 1a and computer 1b illustrated in FIG. 11. The computer 1b may include the function of the encoding unit 110 and the computer 1a may include the function of the search unit 120, or the computer 1a may include the function of the encoding unit 110 and the computer 1b may include the function of the search unit 120. Further, each of the computer 1a and computer 1b may include the function of encoding unit 110 and the function of the search unit 120.

According to an embodiment, a search for target data described in SQL statements is able to be speeded up.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing therein an index generating program that causes a computer to execute a process comprising:
inputting control statements including plural phrases and having contents that change according to description positions of the plural phrases;
generating first index information related to positional information of each of the phrases in the control statements; and
generating, from the first index information, a second index information group related to the phrases targeted by each of reserved words included in the control statements.

2. The non-transitory computer-readable recording medium according to claim 1, wherein sets of second index information included in the second index information group are sets of index information that are respectively: related to the reserved words; and superordinate to a first axis related to offset positions in the first index information.

3. The non-transitory computer-readable recording medium according to claim 1, wherein the first index information respectively includes, along a second axis, the reserved words included in the plural phrases, and the phrases targeted by the reserved words.

4. An index generating apparatus comprising:
a processor configured to:
input control statements including plural phrases and having contents that change according to description positions of the plural phrases;
generate first index information related to positional information of each of the phrases in the control statements; and
generate, from the first index information, a second index information group related to the phrases targeted respectively by reserved words included in the control statements.

5. An index generating method comprising:
inputting control statements including plural phrases and having contents that change according to description positions of the plural phrases;
generating first index information related to positional information of each of the phrases in the control statements, by a processor; and
generating, from the first index information, a second index information group related to the phrases targeted respectively by reserved words included in the control statements.
